(19) United States
(12) Patent Application Publication
(10) Pub. No.: US 2022/0297970 A1
(43) Pub. Date: Sep. 22, 2022

(54) Wrapping Material Roll Storage and Dispensing Device

(71) Applicant: Kelly Galvez, Manassas, VA (US)

(72) Inventor: Kelly Galvez, Manassas, VA (US)

(21) Appl. No.: 17/693,514

(22) Filed: Mar. 14, 2022

Related U.S. Application Data
(60) Provisional application No. 63/164,101, filed on Mar. 22, 2021.
(60) Provisional application No. 63/175,095, filed on Apr. 15, 2021.

(51) Int. Cl. B65H 35/06; B65D 83/08; F16B 47/00

(52) U.S. Cl. CPC B65H 35/06; B65D 83/0882; F16B 47/006

(57) ABSTRACT

The present invention relates to a wrapping material storage and dispensing device. The device has a plurality of containers, wherein each container is configured to store a wrapping material roll and has a sliding cutter to dispense and tear a fixed and desired length of the wrapping material sheet from each roll. Each container has a pair of rollers that enable rolling of the wrapping material roll when the wrapping material is dispensed. The device includes suction cups at the base and/or rear to secure the container(s) on a counter surface or mount to a wall. The device easily stores, organizes, conserves and enables single-handed pulling out or dispensing of specific lengths of wrapping material.

### CROSS-REFERENCE TO RELATED APPLICATION

The present application claims priority to, and the benefit of, U.S. Provisional Application No. 63/164,101, which was filed on Mar. 22, 2021 and U.S. Provisional Application No. 63/175,095, which was filed on Apr. 15, 2021, both of which are incorporated herein by reference in their entirety.

### FIELD OF THE INVENTION

The present invention relates generally to the field of dispenser units. More specifically, the present invention relates to an improved wrapping material storage and dispensing device that enables the users to easily store and organize wax paper, paper towels, aluminum foil, plastic wrap and more, and dispense a required or desired amount of product type as per the needs of the user. The wrapping product storage and dispensing device features one or more storage compartments for storing rolls of different kinds of rolling material or multiple rolls of the same rolling material.

The storage compartments comprise double doors on each front surface for accessing the wrapping material, and a slider cutting mechanism to allow the user to cut the required material sheet of a desired length. Additionally, the wrapping product storage and dispensing device utilizes keyholes or locking suction cups on the rear surface and/or bottom surface of the device, that allow the device to be easily secured to a flat countertop surface, wall or any other desired areas. Furthermore, the wrapping product storage and dispensing device may further comprise one or more rollers on its side to retract materials when too much material has been pulled. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, various kinds of rolling materials such as wax paper, aluminum foil, plastic wrap, parchment paper, paper towels, etc., are commonly used in the kitchen for cooking, storing food and more. Owning multiple different types of wrappings requires that users properly store these products and organize them. However, it may be difficult to find storage space for storing too many rolling material products. Improper storage can lead to cluttered and unorganized drawers and countertops. Also, in case the rolling material products/wrappings are stored in cabinets, drawers and other locations with kitchen tools, utensils, or the like, individuals may be unable to quickly locate the desired wrapping product. Without a specific storage location for the wrappings, a lot of the user's time can be wasted.

Additionally, with the standard wrappings/rolling material products, individuals may find it difficult to tear/cut off or retract a specific amount of product from the roll. Individuals may lose the edge of the wrap and be forced to search for it (potentially cutting a finger on the metal cutting teeth on standard packages) each time they want to obtain a new section of wrapping. Further, cutting away a desired length of wax paper, aluminum foil, etc., can be difficult with the standard cutter mechanisms installed on the packaging. With the standard cutter mechanisms, uneven cutting can occur, forcing individuals to throw away the uneven length and obtain a new piece. Therefore, the wrapping material is not properly used and may be wasted. Further, with conventional wrapping material rolls, pulling out the required amount of the wrapping product may cause individuals to inadvertently pull-out unneeded wrapping product, and may end up rolling back the additional product length to the roll. This may be a frustrating task for the user and can be a waste of time. In addition, current methods to remove a desired amount of product include a two-handed operation, wherein one hand pulls on the product while the other hand holds the carton or container.

Therefore, there exists a long felt need in the art for a storage device that allows users to store one or more wrappings or rolling material products. There is also a long felt need in the art for a device that ensures the wrappings are properly stored and organized, and enables the users to locate the required wrapping material easily and quickly for cooking, storing food or other purposes. Additionally, there is a long felt need in the art for a wrapping material storage device that prevents drawers and countertops from being cluttered and unorganized, and maintains a neat and clean kitchen environment. Moreover, there is a long felt need in the art for a wrapping material storage and dispensing device that allows the users dispense desired amounts of the wrapping material without wasting the product. Further, there is a long felt need in the art for a wrapping product dispensing device that prevents users from getting injured while using the cutter mechanisms for cutting off the wrapping product. Furthermore, there is a long felt need in the art for a wrapping product dispensing device that features easy retraction when too much wrapping material is pulled out of the roll. Finally, there is a long felt need in the art for a wrapping material storage and dispensing device that makes it much easier to store, organize, conserve and pull-out specific lengths of wrapping in the kitchen.

The subject matter disclosed and claimed herein, in one potential embodiment thereof, comprises a multi-tier wrapping product storage and dispenser unit. The multi-tier wrapping product storage and dispensing device stores a plurality of wrapping material rolls and independently dispenses material from one or more rolls. The multi-tier storage and dispensing device includes a plurality of tiered storage containers disposed adjacent to each other and vertically disposed one above another. Each storage container individually includes a cavity to store a wrapping material roll, a pair of rollers disposed on the side surfaces for rolling the wrapping material roll, a front surface having an upper flap, and a bottom portion wherein the upper flap is configured to create an opening for accessing the wrapping material rolled on the roll by flipping back onto a lid and a sliding cutter having serrated metal teeth disposed on a top edge of the bottom portion, to slide along the top edge to tear or cut a sheet of wrapping material extending from the opening.

In this manner, the novel multitier wrapping product storage and dispensing device of the present invention accomplishes all of the forgoing objectives, and provides a relatively safe, easy and convenient solution to store and organize wax paper, paper towels, aluminum foil, plastic wrap and more. The device is easy to store and position, and utilizes keyholes, locking suction cups or similar structures on the rear side and/or bottom side to secure the device to a flat countertop surface or mount to a wall. The invention eliminates the need to use the metal cutting teeth on standard wrapping packages that are often inefficient and difficult to utilize.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one potential embodiment thereof, comprises a wrapping material storage and dispensing device. The device is configured to store a roll(s) of wrapping material and dispense a desired length of wrapping material sheet. The device further comprises: a cuboidal container having a front surface, a rear surface, a base, a top lid, a left side surface and a right-side surface; a cavity created by the front surface, the rear surface, the base, the top lid, the left side surface and the right-side surface; the left side surface having a first roller and the right side surface having a second roller; the cavity is configured to receive a roll of a wrapping material wherein the roll is engaged to the first roller and the second roller; the front surface having an upper flap and a bottom portion; the upper flap is configured to create an opening for accessing the wrapping material rolled on the roll by flipping back onto the lid; and, a sliding cutter including serrated metal teeth disposed on a top edge of the bottom portion, wherein the sliding cutter is configured to slide along the top edge to tear or cut a sheet of wrapping material extending from the opening.

In yet another embodiment of the present invention, the rollers are configured to roll the wrapping material roll when a free edge of the material is pulled. Further, the wrapping material roll is replaceable, and the top lid can be rotated along a hinged edge to remove an existing or depleted wrapping material roll and insert a new roll.

In yet another embodiment of the present invention, the base includes a pair of suction cups enabling the wrapping material storage and dispensing device to be securely placed on a counter surface or wall surface, wherein a lever can be disposed on a rear surface and actuated to lock and unlock the suction cups. Alternatively, the device may comprise keyholes on its back surface for hanging the device on a wall.

In yet another embodiment of the present invention, the sliding cutter includes a plurality of serrated teeth, for example, three, four, five or more serrated teeth. The sliding cutter includes a cavity on which the sliding cutter sits on the top edge of the bottom portion, and is configured to slide across the top edge of the bottom portion.

In yet another embodiment of the present invention, a method of cutting precise or desired lengths of wrapping material sheet is described. The method comprises: providing a wrapping material roll storage and dispensing device; placing a wrapping material roll inside a cavity of the device; creating an opening on a front surface of the device by lifting the upper portion of the front surface and placing the upper portion onto the lid; pulling a free end of the wrapping material rolled on the roll from the created opening once a desired length of the sheet is pulled; and, sliding a sliding cutter along a top edge of bottom portion of the front surface, wherein the sliding cutter includes a plurality of teeth to tear or cut the sheet. In yet another embodiment, the method further includes removing a lid of the device to remove an existing or depleted roll and replace it with a new roll of wrapping material.

In yet another embodiment of the present invention, a multi-tier wrapping product storage and dispensing device is disclosed. The multitier wrapping product storage and dispensing device is designed to store a plurality of wrapping material rolls and independently dispense material from one or more rolls. The multi-tier storage and dispensing device includes: a plurality of tiered storage containers disposed adjacent to each other and vertically disposed one above another; each storage container individually includes a cavity to store a wrapping material roll; a pair of rollers disposed on the side surfaces for rolling and unrolling the wrapping material roll; a front surface having an upper flap and a bottom portion; the upper flap is configured to create an opening for accessing the wrapping material rolled on the roll by flipping back onto a lid; a sliding cutter having serrated metal teeth disposed on a top edge of the bottom portion, wherein the sliding cutter is configured to slide along the top edge to tear or cut a sheet of wrapping material extending from the opening; the multi-tier storage and dispensing device includes a plurality of suction cups and hanging holes (such as keyholes) for mounting the multitier storage and dispensing device to a wall; and a pair of holder arms attached to a bottom surface of the multi-tier storage and dispensing device configured to detachably attach a paper towel roll.

In a further embodiment of the present invention, each cavity of the multitier storage and dispensing device stores a separate wrapping material roll and includes a separate sliding cutter, thereby enabling a precise length of the sheet to be torn off from the individual container. In a further embodiment of the present invention, the number of containers in the multitier storage and dispensing device can be in the range of two to five. A storage space can be disposed at the top of the multitier storage and dispensing device for storing at least one roll and any other personal items.

Advantageously, the device of the present invention allows quick and effective storage and dispensing of precise lengths of wrapping material in kitchens in both home and commercial settings, thereby saving extensive time and effort by precisely cutting the wrapping material. The invention can be used for storing and dispensing aluminum foil, plastic wrap, wax paper and more, and provides even and uniform cutting of the material sheet.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a wrapping material storage and dispensing device of the present invention in accordance with the disclosed architecture;

FIG. 2 illustrates a perspective view showing how a roll of a wrapping material is stored within a cavity of one potential embodiment of the wrapping material storage and dispensing device of the present invention in accordance with the disclosed architecture;

FIG. 3 illustrates a perspective view showing how the wrapping material is accessed for use from an opening created by an upper flap of one potential embodiment of the wrapping material storage and dispensing device of the present invention in accordance with the disclosed architecture;

FIG. 4 illustrates a perspective view of a sliding cutter used for cutting a desired length of wrapping material in accordance with the disclosed architecture;

FIG. 5 illustrates a perspective view of another potential embodiment of a wrapping material storage and dispensing device having space for a plurality of wrapping material rolls in accordance with the disclosed architecture;

FIG. 6 illustrates a rear perspective view of another potential embodiment of wrapping material storage and dispensing device having space for a plurality of wrapping material rolls in accordance with the disclosed architecture; and

FIG. 7 illustrates a perspective view showing a sheet of wrapping material being pulled from a wrapping material roll stored in a middle-tiered container of one potential embodiment of the wrapping material storage and dispensing device in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention, and do not limit the scope of the invention. Additionally, an illustrated embodiment need not have all the aspects or advantages shown. Thus, in other embodiments, any of the features described herein from different embodiments may be combined.

As noted above, there exists a long felt need in the art for a storage device that allows the users to store one or more wrappings or rolling material products. There is also a long felt need in the art for a device that ensures the wrappings are properly stored and organized, and enables users to locate the required wrapping material easily and quickly for cooking, storing food or other purposes. Additionally, there is a long felt need in the art for a wrapping material storage device that prevents drawers and countertops from being cluttered and unorganized, and maintains a neat and clean kitchen environment. Moreover, there is a long felt need in the art for a wrapping material storage and dispensing device that allows the users dispense desired amounts of the wrapping material without wasting the product. Further, there is a long felt need in the art for a wrapping product dispensing device that prevents the users from getting injured while using the cutter mechanisms for cutting the wrapping product. Furthermore, there is a long felt need in the art for a wrapping product dispensing device that features easy retraction when too much wrapping material is pulled out of the roll. Finally, there is a long felt need in the art for a wrapping material storage and dispensing device that makes it much easier to store, organize, conserve and pull-out specific lengths of wrapping in the kitchen.

The present invention, in one potential embodiment, is a wrapping material storage and dispensing device. The device stores a roll of wrapping material and dispenses a desired length of wrapping material sheet. The device includes: a cuboidal container having a front surface, a rear surface, a base, a top lid, a left side surface and a right-side surface; a cavity created by the front surface, the rear surface, the base, the top lid, the left-side surface and the right-side surface; the left-side surface includes a first roller and the right-side surface includes a second roller; the cavity is configured to receive a roll of a wrapping material wherein the roll is engaged to the first roller and the second roller; the front surface having an upper flap and a bottom portion; the upper flap is configured to create an opening for accessing the wrapping material rolled on the roll by flipping back a top portion or upper flap; and, a sliding cutter having serrated metal teeth disposed and actuated along a top edge of the bottom portion, wherein the sliding cutter is configured to slide along the top edge to tear or cut a sheet of wrapping material extending from the opening.

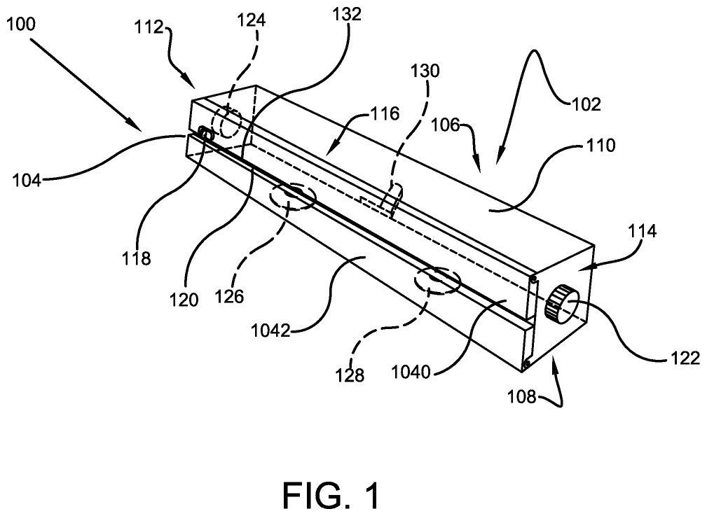

Referring initially to the drawings, FIG. 1 illustrates a perspective view of one potential embodiment of a wrapping material storage and dispensing device of the present invention in accordance with the disclosed architecture. The wrapping material storage and dispensing device 100, in one exemplary configuration, can be designed to hold a single cylindrical wrap of aluminum foil, plastic wrap, or other similar wrapping materials. The wrapping material can be dispensed by pulling out a precise length of the wrapping material. More specifically, the wrapping material storage and dispensing device 100 includes a cuboidal container 102 that includes a front surface 104, a rear surface 106, a base 108, a top lid 110, a left-side surface 112 and a right-side surface 114. The container 102 can be constructed of materials including plastic, metals and/or polymers. The aforementioned surfaces create a cavity 116 to accommodate a wrapping material cylindrical roll. The front surface 104 includes an upper flap 1040 at the top half that can be lifted up and flipped back onto lid 110, enabling a user to access the wrapping material stored within the cavity 116. The bottom edge 132 of the upper flap 1040 is used for lifting the upper flap 1040 to access the wrapping material. The bottom portion 1042 of the front surface 104 is fixed and stationary, and a sliding cutter 118 configured to slide along the bottom portion 1042 is positioned on the top edge 120 of the bottom portion 1042.

The left-side surface 112 includes a first roller 122 and the right-side surface 114 includes a second roller 124, on which a cylindrical wrapping foil can be detachably attached. When the wrapping material is pulled by a user from the upper flap 1040, the rollers 122, 124 rotate in a first or clockwise direction, thereby enabling a user to get a desired length of the wrapping material in the form of a wrapping sheet. The rollers 122, 124 are integrated to the side surfaces 112, 114, respectively, and can be integrally molded with the side surfaces. For enabling the wrapping material storage and dispensing device 100 to be securely positioned on a surface, the bottom surface 108 can include a pair of locking suction cups 126, 128. The suction cups 126, 128 keep the container 102 stable and affixed while dispensing the wrapping material. A lever 130 can be positioned on the rear surface 106 and used for locking and unlocking the suction cups 126, 128.

The wrapping material storage and dispensing device 100 allows a user to store, organize, conserve and dispense specific lengths of wrapping material in the kitchen or other areas without any wastage or unwanted length of the material being inadvertently dispensed. The designated length of wrapping material can be dispensed with one hand, and then subsequently cut to length using the sliding cutter. Both actions can be conducted with the same hand.

The cuboidal container 102 can be made of a rigid and/or non-deformable material, such as ABS or molded plastic, metal, wood, etc. Plastics can be low-density or high-density polyethylene, polystyrene, poly vinyl chloride, polypropylene or similar plastics. Metals can comprise steel, stainless steel, aluminum, copper, etc. The container 102 is lightweight and easily portable.

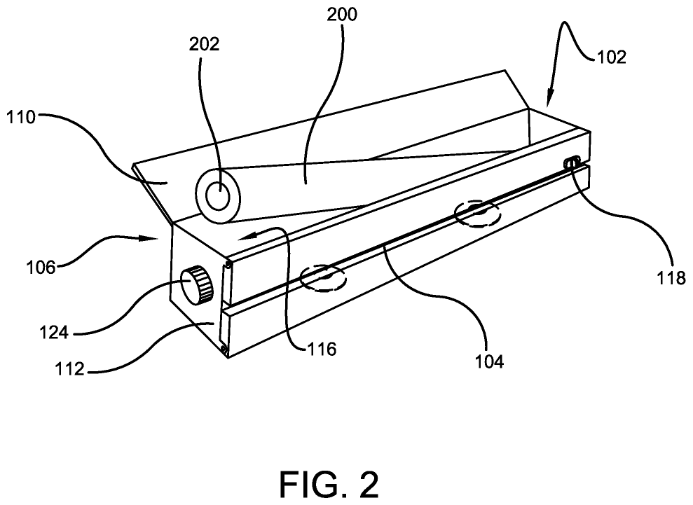

FIG. 2 illustrates a perspective view showing how a roll of a wrapping material is stored within cavity of one potential embodiment of the wrapping material storage and dispensing device of the present invention in accordance with the disclosed architecture. For storing a wrapping material roll 200 in the cavity 116 of the container 102, the lid 110 can be opened along the hinged edge 1100 to access the cavity 116. Once the cavity 116 is accessed, the wrapping material roll 200, that is generally cylindrical in shape and includes a central axial opening 202, can be inserted through the opening created by the lid 110. The axial opening 202 can be aligned and engaged around the rollers 124 (and 122 as shown in FIG. 1). The roll 200 can be configured to roll in a direction from the rear surface 106 towards the front surface 104 when the wrapping material is pulled. The roll 200 can roll in a direction from the front surface 104 towards the rear surface 106 when the material is retracted on the roll 200. Once the roll 200 is securely placed on the rollers, the lid 110 can be closed to cover the cavity 116. The method of replacing an existing or depleted roll 200, with a new roll follows the same principle, where the top lid 110 is opened along the hinged edge 1100 for accessing the cavity 116.

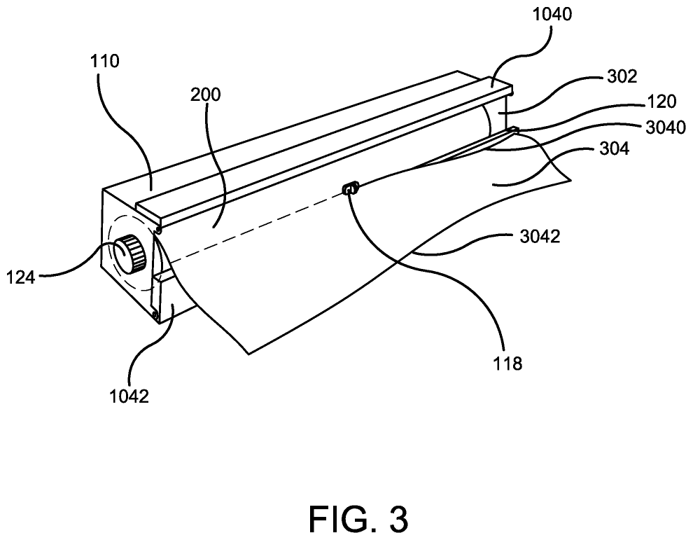

FIG. 3 illustrates a perspective view showing how the wrapping material is accessed for use from an opening created by an upper flap of the wrapping material storage and dispensing device of the present invention in accordance with the disclosed architecture. As shown in FIG. 3, for accessing a desired length of wrapping material from the wrapping material roll 200, the upper flap 1040 can be lifted and flipped back onto the lid 110 to create an opening 302 from which the material sheet 304 is accessed. Once a desired length of sheet 304 is pulled by a user using the free edge 3042, the sliding cutter 118 is slid along the bottom edge 120 of the bottom portion 1042 to tear or cut the desired sheet 304 along the edge 3040. Once the desired sheet length 304 is accessed and cut, the upper flap 1040 can be pulled downward to position the upper flap 1040 to cover the opening 302.

When the sheet 304 is pulled, the roll 200 is rolled using the rollers 124 (and 122 as shown in FIG. 1) towards the opening 302, and the presence of finger indents assists with starting the wrapping material from where it was left off in the preceding use. It should be appreciated that the container 102 does not have metal cutting teeth along the top edge 120, as found in standard wrapping packages and potentially injure the fingers of a user. Further, a specific length of the wrapping material from the roll 200 can be pulled and then cut using the sliding cutter 118.

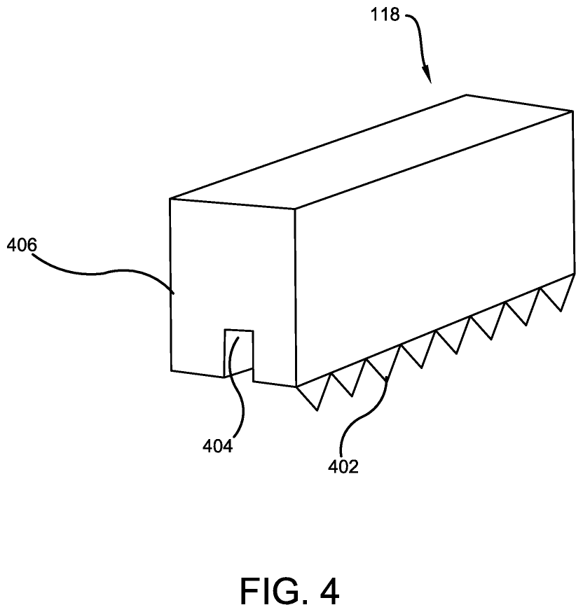

FIG. 4 illustrates a perspective view of a sliding cutter used for cutting a desired length of wrapping material in accordance with the disclosed architecture. The sliding cutter 118 is designed to slide along top edge 120 of the bottom portion 1042 of the front surface 104 of the container 102. The sliding cutter 118 includes a plurality of serrated metal teeth 402 configured to tear or cut through the wrapping material smoothly and uniformly along the top edge 120. In one potential embodiment, the number of serrated metal teeth 402 can be two, three or four, or alternatively, the number of serrated metal teeth 402 can be five or more. A slot 404 is configured to actuate along the top edge 120, and allows the sliding of the sliding cutter 118 along the top edge 120. During a wrapping material cutting operation, the serrated metal teeth 402 smoothly tear or cut the wrapping material along the lateral length of the wrapping material. A rear surface 406 of the sliding cutter 118 actuates along an inner surface of the bottom portion 1042, and helps in secure and smooth movement of the sliding cutter 118 along the top edge 120.

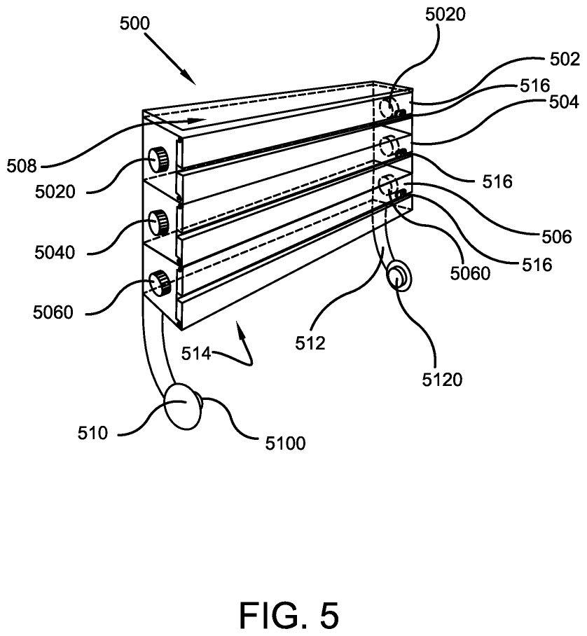

FIG. 5 illustrates a perspective view of another embodiment of a wrapping material storage and dispensing device having space for a plurality of wrapping material rolls in accordance with the disclosed architecture. In the present embodiment the wrapping material storage and dispensing device 500 includes a tiered structure, containing a plurality of individual tiered containers connected longitudinally to hold a plurality of rolls for use. As shown, the multiple roll storage and dispensing device 500 includes three tiered containers 502, 504, 506 connected to each other in a longitudinal manner. The top tiered container 502 includes a pair of rollers 5020 to receive a roll of a wrapping material such as aluminum foil, plastic wrap or wax paper. Similarly, the middle container 504 includes a pair of rollers 5040 to receive a wrapping material roll. The bottom container 506 also includes a corresponding pair of rollers 5060 for receiving a wrapping material roll.

The device 500 includes removable paper towel holder arms 510, 512 permanently attached to the bottom surface 514. The first arm 510 includes a first holder 5100 and the second arm 512 includes a second holder 5120 enabling a roll of paper towels to selectively detach and attach to the holders 5100, 5120. The first arm 510 and the second arm 512 are movable, and can be oriented as per the preferences of the user. The device 500 includes a storage space 508 disposed on the top of the top tiered container 502 for storing a new wrapping material roll or any other small item.

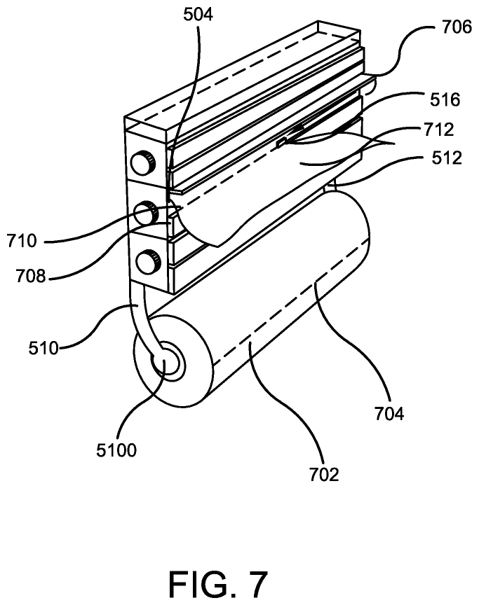

Each tiered container 502, 504, 506 includes a front surface similar to that as shown in FIG. 1. The upper flap of the front surface of each container 502, 504, 506 can be pivoted upward, enabling an opening to access the wrapping material from each container as best illustrated in FIG. 7. Each individual container 502, 504, 506 can be operated individually, thereby enabling a user to store three rolls in total, wherein each roll can be operated and used individually. Each container includes a sliding cutter 516, enabling a sheet of wrapping material to tear or cut easily and uniformly. The sliding cutter 516 can have a plurality of teeth, thereby enabling the cutter 516 to tear or cut the wrapping material sheet.

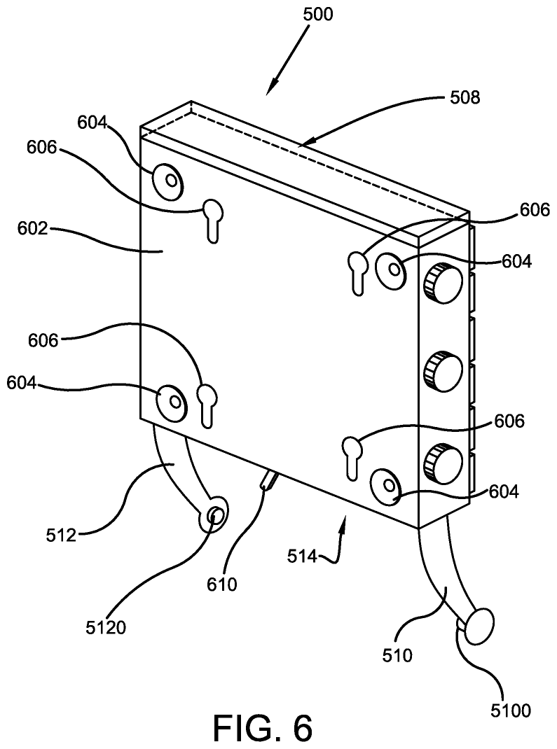

FIG. 6 illustrates a rear perspective view of another embodiment of the wrapping material storage and dispensing device having space for a plurality of wrapping material rolls, in accordance with the disclosed architecture. The multiple-roll storage and dispensing device 500 includes a wall-mounted device, wherein the rear wall 602 includes a plurality of suction cups 604 to adhere to a wall. The rear wall 602 also includes a plurality of small keyholes 606 to hang the device 500 to a wall. At the top of the device 500, the storage space 508 is used for storing rolls of the wrapping material.

When the device 500 is mounted to a wall, the paper towel holder arms 510, 512 are oriented away from the rear wall 602, thereby enabling a user to easily access the paper towel roll engaged to the holders 5100, 5120. For locking the suction cups 604, a lever 610 is disposed at the bottom surface 514, which can be pulled or pushed to activate or deactivate the suction cups 604.

FIG. 7 illustrates a perspective view showing a sheet of wrapping material being pulled from a wrapping material roll stored in a middle-tiered container of the wrapping material storage and dispensing device in accordance with the disclosed architecture. As shown, the middle-tiered container 504 stores a wrapping material roll 710 and accesses a sheet 716 from the wrapping material roll 710. The upper flap 706 can be lifted to creating an opening to pull the sheet 712, thereby enabling the sliding cutter 516 to slide along the bottom portion 708 to tear or cut a desired and uniform length of the sheet 712. A similar operation of accessing and cutting the wrapping material sheet 712 from the stored wrapping material rolls in each container is followed.

In use, the upper flap of each container is flipped back onto a corresponding lid to create an opening to access the stored roll and tear or cut a uniform sheet of the wrapping material. Once the sheet of a desired length is torn, the upper flap is positioned to close the opening for securing the wrapping material roll. The paper towel roll 702 is rolled using the holders 5100, 5120, and can be torn along the perforated lines 704. Furthermore, the wrapping product storage and dispensing device may further comprise one or more rollers on its side (not shown) to retract materials when too much material has been pulled.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “wrapping material storage and dispensing device”, “multitier wrapping product storage and dispenser unit”, and “device” are interchangeable and refer to the wrapping material storage and dispensing device 100, 500 of the present invention.

Notwithstanding the forgoing, the wrapping material storage and dispensing device 100,500 of the present invention can be of any suitable size and configuration as is known in the art without affecting the overall concept of the invention, provided that it accomplishes the above-stated objectives. One of ordinary skill in the art will appreciate that the size, configuration, and material of the wrapping material storage and dispensing device 100, 500 as shown in the FIGS. are for illustrative purposes only, and that many other sizes and shapes of the multipurpose plate with the wrapping material storage and dispensing device 100, 500 are well within the scope of the present disclosure. Although the dimensions of the multipurpose plate with the wrapping material storage and dispensing device 100, 500 are important design parameters for user convenience, the wrapping material storage and dispensing device 100, 500 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A wrapping material storage and dispensing device comprising:
a dispensing device comprising a container for storing a roll of wrapping material and dispensing a desired length of said wrapping material;
said container having a front surface, a rear surface, a base, a top lid, a left side surface and a right-side surface;
a cavity bordered by said front surface, said rear surface, said base, said top lid, said left side surface and said right-side surface, wherein said left side surface including a first roller and said right side surface including a second roller;
said cavity is configured to receive said roll of wrapping material, wherein said roll of wrapping material is engaged between said first roller and said second roller;
said front surface including an upper flap and a bottom portion;
said upper flap is selectively openable for accessing said roll of wrapping material, wherein an end of the wrapping material is accessed by rotating said upper flap upward; and
a sliding cutter including a cutting edge disposed on a top edge of said bottom portion, wherein said sliding cutter slidable along said top edge to cut said desired length of said wrapping material extending from an opening of said container.

2. The wrapping material storage and dispensing device of claim 1, wherein said container is a cuboidal container.

3. The wrapping material storage and dispensing device of claim 2, wherein said cutting edge includes serrated metal teeth.

4. The wrapping material storage and dispensing device of claim 3, wherein said first roller and said second roller are configured to roll said wrapping material roll when a free edge of the material is pulled.

5. The wrapping material storage and dispensing device of claim 4, wherein said wrapping material roll is replaceable.

6. The wrapping material storage and dispensing device of claim 5, wherein said top lid rotatable along a hinged edge to remove a depleted wrapping material roll and insert a new roll.

7. The wrapping material storage and dispensing device of claim 1, wherein said base includes a plurality of suction cups for securing said container on a counter surface.

8. The wrapping material storage and dispensing device of claim 1, wherein said rear surface includes a plurality of suction cups for securing said container to a wall surface.

9. The wrapping material storage and dispensing device of claim 7 further comprising a lever disposed on said rear surface and actuated to lock and unlock said plurality of suction cups.

10. A wrapping material storage and dispensing device comprising:
a dispensing device including a container for storing a roll of wrapping material and dispensing a desired length of said wrapping material;
said container having a front surface, a rear surface, a base, a top lid, a left side surface and a right-side surface;
a cavity bordered by said front surface, said rear surface, said base, said top lid, said left side surface and said right-side surface, wherein said left side surface including a first roller and said right side surface including a second roller;
said cavity is configured to receive said roll of wrapping material, wherein said roll of wrapping material is engaged between said first roller and said second roller;
said front surface including an upper flap and a bottom portion;
said upper flap is selectively openable for accessing said roll of wrapping material, wherein an end of the wrapping material is accessed by rotating said upper flap upward;
a sliding cutter including a cutting edge disposed on a top edge of said bottom portion, wherein said sliding cutter slidable along said top edge to cut said desired length of said wrapping material extending from an opening of said container; and
said base includes a plurality of suction cups for securing said container on a counter surface.

11. The wrapping material storage and dispensing device of claim 10, wherein said dispensing device including another container for storing another roll of wrapping material and dispensing another desired length of said wrapping material;
said another container having a front surface, a rear surface, a base, a top lid, a left side surface and a right-side surface;
another cavity of said another container bordered by said front surface, said rear surface, said base, said top lid, said left side surface and said right-side surface, wherein said left side surface including a first roller and said right side surface including a second roller;
said another cavity is configured to receive said another roll of wrapping material, wherein said another roll of wrapping material is engaged between said first roller and said second roller;
said front surface of said another container including an upper flap and a bottom portion; and
said upper flap of said another container is selectively openable for accessing said another roll of wrapping material.

12. The wrapping material storage and dispensing device of claim 10, wherein said cutting edge includes serrated metal teeth.

13. The wrapping material storage and dispensing device of claim 10, wherein said first roller and said second roller are configured to roll said wrapping material roll when a free edge of the material is pulled.

14. The wrapping material storage and dispensing device of claim 10, wherein said wrapping material roll is replaceable.

15. The wrapping material storage and dispensing device of claim 10, wherein said top lid rotatable along a hinged edge to remove a depleted wrapping material roll and insert a new roll.

16. The wrapping material storage and dispensing device of claim 10, wherein said rear surface includes a pair of suction cups for securing said container to a wall surface.

17. A method of cutting desired lengths of wrapping material sheets from a plurality of rolls of material, the method comprising the steps of:
providing a plurality of dispensing containers, wherein at least one dispensing container is stacked adjacent to at least another dispensing container;
placing a wrapping material roll inside a cavity of said at least one dispensing container and at least another dispensing container;
creating an opening on a front surface of said at least one dispensing container and at least another dispensing container by lifting an upper portion of a front surface of said at least one dispensing container and by lifting an upper portion of a front surface of said at least another dispensing container;
selectively pulling a free end of the wrapping material rolled on said wrapping material roll from said opening of said at least one dispensing container or said opening of said at least another dispensing container roll of material to the desired length of wrapping material sheet; and, sliding a first cutter along a top edge of a bottom portion of said front surface of said at least one dispensing container to cut the desired lengths of wrapping material sheets.

18. The method of claim 17, wherein one of said at least one dispensing container and said at least another dispensing container includes a base having a plurality of suction cups for securing to a counter surface.

19. The method of claim 17, wherein said at least one dispensing container and said at least another dispensing container include a rear surface having a plurality of suction cups for securing to a wall surface.

20. The method of claim 17 further comprising a step of sliding a second cutter along a top edge of a bottom portion of said front surface of said at least another dispensing container to cut another sheet.
